(19) United States
(12) Patent Application Publication
(10) Pub. No.: US 2013/0346124 A1
(43) Pub. Date: Dec. 26, 2013

(54) SYSTEM AND METHOD FOR DETERMINING A COMPATIBLE GROUP TRAVEL ITINERARY

(71) Applicant: Robert A. Stern, Los Altos, CA (US)

(72) Inventors: Robert A. Stern, Los Altos, CA (US); Roxanne Stern, Los Altos, CA (US); Kathryn Stern, Los Altos, CA (US); Andrew C. Stern, Los Altos, CA (US)

(21) Appl. No.: 13/921,773

(22) Filed: Jun. 19, 2013

Related U.S. Application Data
(60) Provisional application No. 61/663,168, filed on Jun. 22, 2012.

(51) Int. Cl. G06Q 10/02

(52) U.S. Cl. CPC G06Q 10/025
USPC 705/6

(57) ABSTRACT

A method and system are provided for determining a group travel destination and compatible travel itinerary for a travel party to travel on a trip together. A unique identifier is created or used by each individual traveler, and each individual traveler is asked a series of hierarchical questions concerning parameters for travel in order to create a profile. Multiple traveler profiles are linked to form a set of travel party data. After further refining and polling a common destination and a common set of travel dates is selected from possible travel dates after a lookup by the system in each travelers individual calendars.

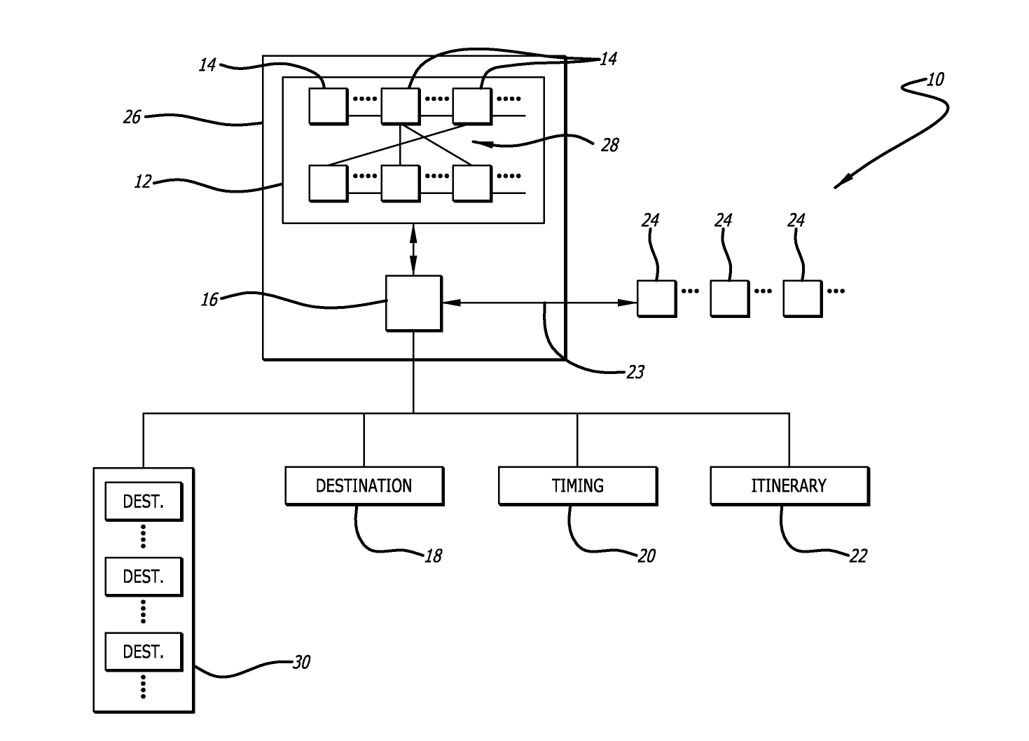

### CROSS-REFERENCES TO RELATED APPLICATIONS

This application is based upon and claims priority from U.S. Provisional Application No. 61/663,168, filed Jun. 22, 2012, incorporated by reference in its entirety.

### BACKGROUND

The present invention relates generally to the field of travel planning, and more particularly relates to a method and system for determining a common destination and itineraries or a common destination with unique itineraries which is most compatible for all the members of a prospective travel group.

One of the problems in determining a travel itinerary for a group of individuals seeking to travel together is picking a particular destination that will appeal to the entire group. Individuals have unique and disparate travel preferences as to where and how they would like to travel, and what they will enjoy at a destination. One conventional travel management method, which is the currently available standard for coordinating group travel itineraries for multiple travelers, involves providing different suggested outbound and inbound itineraries for each traveler based upon a destination location, a plurality of origin locations for at least one traveler each, and a travel database including outbound and inbound itineraries between the origin locations and the destination location. A conventional automated internet based interactive travel planning and management system is also known that includes a web-based planning and reservation interface system and an interactive access device that contacts travel service providers to arrange for every aspect of an individual traveler's trip.

There are no tools that currently allow members of a prospective travel group to create a personal travel profile by answering a series of questions on a mobile device connected to a program, computer program, website, or mobile device application, either in conjunction with a potential trip or as part of joining a social network, which then stores each group member's personal travel likes and dislikes as a profile in a unique database, wherein the unique profile can then be linked to other travelers profiles in order to help choose a destination, itinerary and potential travel date, that would be acceptable for every traveler. It would be desirable to provide a method and system for determining a common travel destination, date, and a compatible general travel itinerary for a travel party group of two or more individuals. It would also be beneficial to allow individual travelers to link their individual travel profiles by mobile devices connected to a program, computer program, website, or mobile device application or other means with one or more people, for example, couples, families, friends, or other groups to create a group travel profile that could be used to choose a common destination and a common travel date that would be acceptable to all individuals in the travel party, but would provide a unique travel itinerary for the common destination to all members of the travel party, so that they would know that once they arrived at the common destination they would have activities and events that they would enjoy available at the chosen destination. The present invention meets these and other needs.

### SUMMARY OF THE INVENTION

The invention provides a method and system for a group of potential travelers to determine a common travel destination, and either a unique or common itinerary for that destination for each potential traveler. The program can also look up a list of the potential common travel dates on each traveler's mobile device, which may be connected to a program loaded on the device, computer program, website, or mobile device application. The preferred embodiment is a program, such as a program on a social network, mobile application or website, which allows travelers to create unique profiles which store the travel needs, likes, dislikes, and specific areas of interest of each traveler, which are determined by answering a series of questions on a mobile device connected to a program, computer program, website, or mobile device application or other means, and then the application or program stores this data set in a centralized data store. That profile may be unique for each traveler. After collecting the data, which includes the individual travel preferences generated by answering a series of questions, the program or application would then allow two or more travelers who want to travel together and who have their own personal profiles containing individual likes and dislikes, to link those individual profiles with the intent of finding a common travel destination and potentially a common time within which they can travel. Once the potential travelers' data or profiles are linked, the application examines the underlying likes, dislikes, and dates of availability and can use the accumulated data from the entire travel party to make additional individual and group queries of all linked travel party members, the answers of which once tabulated allow the travel tool to propose alterative travel destinations that will appeal to all individual travelers in the travel party. In a further embodiment, the application, program, or website can determine the ideal travel dates that accommodate all members of the group by checking the calendar of each individual in the group, finding the next free times for travel availability, and comparing that information for each potential member of the group to find an available common travel date. Once a common destination is chosen through agreement and consensus through interaction on individual mobile, computer and or internet connected devices by all travel party members, a series of potential travel dates are proposed by the application as it looks up travel date availability on the individuals' mobile, computer, and/or internet connected devices of all the linked travel members. Once the destination and the timing of the trip is chosen, the application can provide a unique travel itinerary for the group and all individual trip member, as well as present unique travel options for all members depending on their particular requirements. The application will also provide costs of travel and book trips based on each traveler's profile and/or provide the travel group with a group price for all bookings. The preferred embodiment allows for the storage of the individual travel needs, likes, and dislikes as a profile so that data can be linked and used to determine a unique travel destination. These are then compiled to derive a unique itinerary coordinated around a common set of dates with suggestions for travel mode, travel destination, lodging, costs, and unique events that will allow all individuals in the travel party to enjoy both the destination and their shared or unique itinerary.

These and other features of the invention will become apparent from the following detailed description of the preferred embodiments of the invention in conjunction with the accompanying drawing, which illustrate, by way of example, the features of the invention.

### BRIEF DESCRIPTION OF THE DRAWINGS

The FIGURE is a schematic diagram of the system for determining a destination, the timing and a compatible travel itinerary for each of the members of a travel party or travel group of two or more individual travelers to travel on a trip together, according to the invention.

### DETAILED DESCRIPTION OF THE PREFERRED EMBODIMENTS

The present invention provides for a method and system for determining a destination, the timing and a compatible travel itinerary for each of the members of a travel party or travel group of two or more individual travelers to travel on a trip together.

Referring to the drawings, which are provided of purposes of illustration by way of example, and not by way of limitation, the present invention provides for a method and system 10 for determining a common travel destination, date, and a compatible general travel itinerary for a travel party. The system includes a database 12 configured to store a plurality of individual traveler profiles 14. In a presently preferred aspect, the profile database may be a relational database. A processor 16 is connected to the database, and is configured to determine a common travel destination 18, a timing 20, and a compatible travel itinerary 22 for a travel party including a plurality of individual travelers to travel as a group on a trip together. The processor is preferably connected in communication via a network 23, such as a cellular network or the Internet, for example, with a plurality of mobile communications devices 24 of the plurality of individual travelers of the travel party, respectively. The processor may be provided in a file server or a cloud storage device 26 linked to multiple travel data sites to correlate the potential travel destinations and itineraries, for example, and is preferably configured to generate a linkage 28 of the plurality of individual traveler profiles. In one presently preferred aspect, the plurality of mobile communications devices are preferably configured to be connected to the processor and configured to generate a series of unique travel destinations 30 based on the linkage of the plurality of individual traveler profiles.

In the method of the invention, a unique identifier for every traveler in the travel party is initially created through a log-in process or by using a social media log-in or email address for each individual traveler. Once logged into a social network, mobile device connected to a program, computer program, website, or mobile device application or other means, each individual traveler is asked a series of hierarchical questions concerning general parameters for travel such as individual travel needs, likes, dislikes, and areas of interest in which answers provided to the hierarchical questions may generate subsequent hierarchical questions. The answers of each individual traveler are uniquely stored to establish an individual traveler profile. The profiles for each individual traveler may include the individual travel parameters, the general likes and dislikes, cost preferences, and their future availability for dates of travel. In a presently preferred aspect, each travel party includes two or more individual travelers, or one or more groups of a plurality of individual travelers. The hierarchical questions to be asked can include various formats: multiple choice, true or false, or marking all that apply off a general list. Answers to the hierarchical questions can be compiled and utilized on interfaces such as a social network, over the internet, mobile devices connected to a program, computer programs, websites, or mobile device applications or other means.

In a presently preferred aspect, profiles for a travel party including a plurality of individual travelers can be linked by a request for inclusion or by invitation to form a set of travel party data, either for a specific date of travel or for a date that the application generates after checking the travel parties availability. The linkage to create a travel group can be made between friends, family members, or individuals desiring to travel to a common destination. Once the profiles are linked the entire linked profile dataset is run through an algorithm, which is linked to both the profiles and a travel destination and destination information database, which generates another series of queries to narrow down a potential list of destinations based on the linked profile data. Answers to the queries which are posed to all members of the linked travel group members may develop additional queries for final clarification, which are run through the algorithm, but ultimately lead to a proposal of one or more destinations based on the correlation of all the individual travelers' profiles and the answers to the subsequent queries. A plurality of selected possible travel dates can be looked up by the application for each individual traveler on their mobile device or in their local calendar, or even input by an individual traveler, and a series of potential travel dates are proposed from a plurality of selected possible travel dates acquired from each individual traveler. The possible travel dates can include dates over an extended period of time, or can be dates for a unique destination at any time. Individual travelers in the travel party are then polled to obtain provisional acceptance of a common travel destination, travel dates and the travel itinerary for the travel party. After the poll, if direct communication has not been available, then direct communication in the form of a group forum and optional internal group chat is provided to all group members in order to permit the individual travelers in the travel party to discuss travel plans. A separate forum for chat between members of the travel party will provide a private communication link to those members of the travel party that are invited to the forum. One person will be an administrator, and individual members of the travel party are provided additional opportunities to invite new members to the forum to discuss the common travel plan.

Further suggestions can be provided for travel mode, lodging, costs, and unique events based upon the individual data or the travel party data. Each individual traveler in the travel party is additionally queried, and the individuals' personal data and the travel party's collective data can be used to make final bookings for individuals or the group and/or reservation suggestions.

This invention provides a way to determine common destination and appeal to all parties desiring to take a trip together first by creating a unique identifier through a log-in process for each traveler desiring to join a travel party. A further embodiment of the invention would allow the mobile program or application to take into account the specific current geographic location or desired location of an individual traveler or group of travelers of the travel party in order to determine a suggested set of activities, based on the linked profiles of the travel party, or just based on an individual traveler's profile. This particular feature allows users to explore a current or proposed destination's restaurants, shopping districts, hotels, local points of interest, or current activities so when the travel group is in an unfamiliar place or in a place that they would like to further explore they can see what is available based on their profiles.

A benefit of the invention is that if the travelers want to link their travel plans with one or more people, couples, families, or if multiple groups want to create a travel party together, this invention will develop a common destination and a common or unique travel itinerary that will appeal to all individuals in the travel party.

The present invention may also be used to accumulate itinerary data and propose itineraries to other users of the service, based on experiences that are shared by prior travelers, allowing direct and anonymous communication between prior travelers who are interested in guiding future travelers and rating their input. This allows travel parties to see examples and explore destinations that have been previously selected.

The present invention may also be used to allow previous clients to contribute to the development and exploration of itineraries for prospective clients. Once individual travelers select and use a specific itinerary from this invention, they can provide feedback about the various aspects of their trip as related to a series of set categories: where to eat, types of shopping, local events, modes of transportation, hospitals, translators, lodging, suggested budget, outdoor events (with subcategories), and the like. This will also allow other individuals or travel parties who want to have a similar experience to communicate with previous users and ask questions about their trip in a feed that is posted on the site. This feedback will be visible so that other individuals browsing the site can see the personal feedback, thus making the trip that much more user-friendly and appealing since there is direct input from previous users.

It will be apparent from the foregoing that while particular forms of the invention have been described, various modifications can be made without departing from the spirit and scope of the invention.

We claim:

1. A system for determining a common travel destination, date, and a compatible general travel itinerary for a travel party, the system comprising:
a database configured to store a plurality of individual traveler profiles; and
a processor connected to said database and configured to determine a travel destination, a timing and a compatible travel itinerary for a travel party including a plurality of individual travelers to travel as a group on a trip together, said processor being connected in communication with travel destination databases and a plurality of mobile communications devices of said plurality of individual travelers of the travel party, respectively.

2. The system of claim 1, wherein said profile database comprises a relational database.

3. The system of claim 1, wherein said processor is configured to process fuzzy logic to determine the travel destination, itineraries and the timing of the trip.

4. The system of claim 1, wherein said processor comprises a file server.

5. The system of claim 1, wherein said processor comprises a cloud storage device.

6. The system of claim 1, wherein said processor is configured to generate a linkage of said plurality of individual traveler profiles.

7. The system of claim 1, further comprising a plurality of mobile communications devices each configured to be connected to said processor and configured to generate a series of unique travel destinations based on said linkage of said plurality of individual traveler profiles.

8. A method for determining a common travel destination, date, and a compatible general travel itinerary for a travel party to use while they travel on a trip together, comprising the steps of:
providing a database or databases configured to store a plurality of individual traveler profiles;
providing a processor connected to said database or databases and configured to determine a travel destination, a timing and a compatible travel itinerary for a travel party including a plurality of individual travelers to travel as a group on a trip together, said processor being connected in communication with a plurality of mobile communications devices of said plurality of individual travelers of the travel party, respectively;
communicating a plurality of hierarchical questions to each of said individual travelers of said travel party about their travel preferences and preferred travel destinations;
generating said plurality of individual traveler profiles for each of said individual travelers of said travel party from the series of questions;
storing said plurality of individual traveler profiles in said database;
generating a linkage of said plurality of individual traveler profiles in said database to form a set of travel party data;
determining a set of at least one unique travel destination for said individual travelers of said travel party to consider;
determining a plurality of selected possible travel dates for the travel party;
proposing a plurality of potential travel dates based upon the plurality of selected possible travel dates for the travel party; and
determining a group itinerary for said travel party.

9. The method of claim 8, wherein said plurality of hierarchical questions relate to travel needs, likes, dislikes, and specific areas of interest of each of said individual travelers of said travel party.

10. The method of claim 8, wherein said step of communicating a plurality of hierarchical questions comprises generating and communicating an additional plurality of questions to each of said individual travelers of said travel party in order to restrict a potential list of destinations based on the linkage of said plurality of individual traveler profiles.

11. The method of claim 8, wherein said step of generating the plurality of individual traveler profiles comprises refining said profiles by gaining access by request of a social network site of said individual travelers of said travel party.

12. The method of claim 8, wherein said step of generating the plurality of individual traveler profiles comprises refining said profiles by asking said individual travelers of said travel party from at least one answer to at least one additional question.

13. The method of claim 8, wherein said step of generating a linkage comprises linking said plurality of individual traveler profiles of said individual travelers of said travel party by request for inclusion or by invitation.

14. The method of claim 13, wherein said plurality of individual traveler profiles of said individual travelers of said travel party are linked between friends, family or individuals desiring to travel to a common destination.

15. The method of claim 8, wherein said step of determining a set of at least one unique travel destination comprises determining a common destination for said individual travelers of said travel party.

16. The method of claim 8, wherein said step of determining a plurality of selected possible travel dates for the travel party comprises searching for available dates on a calendar of each of the mobile communications devices of said individual travelers of said travel party.

17. The method of claim 8, wherein said step of determining a plurality of selected possible travel dates for the travel party comprises inputting a plurality of selected possible travel dates by said individual travelers of said travel party.

18. The method of claim 8, wherein said step of determining a group itinerary for said travel party comprises comparing the preferences of said individual travelers of said travel party, and asking each of said individual travelers of said travel party to respond to additional queries in order to clarify the proposed destination options.

19. The method of claim 8, further comprising the step of providing each of said individual travelers of said travel party with the group itinerary for the common travel destination based on their travel profile.

20. The method of claim 8, further comprising the step of providing to each of said individual travelers of said travel party with a unique itinerary for the common travel destination based on said plurality of individual traveler profiles.
